(19) United States
(12) Patent Application Publication
(10) Pub. No.: US 2018/0365425 A1
(43) Pub. Date: Dec. 20, 2018

(54) SYSTEMS AND METHODS FOR SECURELY BOOTING A SYSTEM ON CHIP VIA A VIRTUAL COLLATED INTERNAL MEMORY POOL

(71) Applicant: QUALCOMM INCORPORATED, SAN DIEGO, CA (US)

(72) Inventors: DHAMIM PACKER ALI, SAN DIEGO, CA (US); JEFFREY SHABEL, SAN DIEGO, CA (US); YANRU LI, SAN DIEGO, CA (US); ASHUTOSH SHRIVASTAVA, SAN DIEGO, CA (US)

(21) Appl. No.: 15/624,612

(22) Filed: Jun. 15, 2017

(51) Int. Cl. G06F 21/57; G06F 9/44

(52) U.S. Cl. CPC G06F 21/575; G06F 9/4406; G06F 9/4405

(57) ABSTRACT

Systems, methods, and computer programs are disclosed for securely booting a system on chip. One embodiment is a system comprising a system on chip (SoC) and a virtual collated internal memory pool (VCIMP). The SoC comprises a bootable processing device having a first internal memory, a read only memory (ROM), and one or more bootable processing subsystems each having a dedicated internal memory. The bootable processing device is configured to execute a bootloader in the ROM. The VCIMP provides time-shared control and access to the one or more bootable processing subsystems during execution of a boot sequence. The VCIMP comprises a contiguous logical-to-physical address mapping of the first internal memory residing on the bootable processing device and the dedicated internal memories residing on the corresponding one or more bootable processing subsystems.

### DESCRIPTION OF THE RELATED ART

Portable computing devices (e.g., cellular telephones, smart phones, tablet computers, portable digital assistants (PDAs), portable game consoles, wearable devices, and other battery-powered devices) and other computing devices continue to offer an ever-expanding array of features and services, and provide users with unprecedented levels of access to information, resources, and communications. To keep pace with these service enhancements, such devices have become more powerful and more complex. Portable computing devices now commonly include a system on chip (SoC) comprising one or more chip components embedded on a single substrate (e.g., one or more central processing units (CPUs), a graphics processing unit (GPU), digital signal processors, etc.). The SoC may be coupled to one or more volatile memory devices (e.g., dynamic random access memory (DRAM) and one or more non-volatile storage devices (e.g., flash storage) via high-performance data and control interface(s).

In a conventional SoC boot operation, the SoC boots from an internal read only memory (ROM). The boot ROM firmware boot typically requires internal memory and complex drivers to securely boot the SoC over emerging boot devices and interfaces, such as, for example, Universal Flash Storage (UFS), Peripheral Component Interconnect Express (PCle), Non-Volatile Memory Host Controller Interface Specification (NVMe), Universal Serial Bus 3 (USB3), etc. Each boot relies on a combination of different types of bootable processing systems (e.g., multi-core central processing unit (CPU) systems, digital signal processors (DSPs), and other processing subsystems) with different sizes and types of dedicated internal memories (e.g., CPU cache, static random access memory (SRAM), and tightly coupled memory (TCM).

The different types of processor chips and the varying size of their internal memories present unique challenges to securely booting up the SoC. For example, the increasing complexity of SoCs and double data rate (DDR) technologies, increasing secure boot requirements to enable higher hashing and cryptographic algorithms (RSA, error code correction (ECC), etc.), and the variety of storage boot devices and interfaces necessitate significant internal memory size requirements to initialize and calibrate the peripherals while still meeting stringent boot time key performance indicators (KPIs) and performance for multiple market segments (e.g., mobile computer, automotive, and Internet of Things (IoTs).

One potential solution to this problem is to expand or reserve internal memory (e.g., SRAM) that is only required temporarily during boot. However, increasing the SRAM size can add significant area/power cost, and it may increase the average unit cost (AuC) for the SoC if the increased internal memory size cannot be justified for post-boot use cases. Another proposed solution in the context of a heterogeneous processor cluster architecture is to repurpose application processor internal memory (e.g., using a CPU level 2 (L2) cache) as tightly coupled internal memory. However, these solutions are challenged by size. For example, the processors used in a Little processor cluster are typically smaller in size to provide power saving advantages compared to the processors used in a Big processor cluster designed for performance. Furthermore, while enabling higher performance differentiated CPU designs (e.g., ARM-based register transfer level (RTL) designs) can provide faster time-to-market (TTM), they introduce challenges in SoC integration, which may require additional custom wrapper functionality requirements. For example, the addition of custom wrapper functionality may alter the smooth RTL integration and introduce risk to SoC tapeout and verification, which negatively impact TTM. The increased need to optimize process node scaling only makes this integration and TTM even more challenging.

Accordingly, there is a need for improved systems and methods to optimize internal memory usage in the SoC during a secure boot-up.

### SUMMARY OF THE DISCLOSURE

Systems, methods, and computer programs are disclosed for securely booting a system on chip. One embodiment is a system comprising a system on chip (SoC) and a virtual collated internal memory pool (VCIMP). The SoC comprises a bootable processing device having a first internal memory, a read only memory (ROM), and one or more bootable processing subsystems each having a dedicated internal memory. The bootable processing device is configured to execute a bootloader in the ROM. The VCIMP provides time-shared control and access to the one or more bootable processing subsystems during execution of a boot sequence. The VCIMP comprises a contiguous logical-to-physical address mapping of the first internal memory residing on the bootable processing device and the dedicated internal memories residing on the corresponding one or more bootable processing subsystems.

Another embodiment is a method for securely booting a system on chip (SoC). The method comprises powering up an SoC comprising a bootable processing device having a first internal memory, a read only memory (ROM), and one or more bootable processing subsystems each having a dedicated internal memory. The first internal memory residing on the bootable processing device and the dedicated internal memories residing on the corresponding one or more bootable processing subsystems are mapped to a virtual collated internal memory pool (VCIMP). The bootable processing device executes a bootloader in the ROM. The one or more bootable processing subsystems are provided time-shared access to the VCIMP during execution of the bootloader.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of an embodiment of a system on chip (SoC) comprising a time-shared virtual collated internal memory pool (VCIMP) used during a secure SoC boot.

FIG. 2 is a flowchart illustrating an embodiment of a method for securely booting the SoC of FIG. 1 via the time-shared VCIMP.

FIG. 3 illustrates an embodiment of a plurality of dedicated chip internal memories on the SoC used to generate a time-shared VCIMP.

FIG. 4a is an embodiment of a VCIMP memory map for the dedicated chip internal memories of FIG. 3.

FIG. 4b is another embodiment of a VCIMP memory map for the dedicated chip internal memories of FIG. 3.

FIG. 4c is a further embodiment of a VCIMP memory map for the dedicated chip internal memories of FIG. 3.

FIGS. 5a & 5b illustrate another embodiment of a method for securely booting the SoC of FIG. 1 using a time-shared VCIMP.

FIG. 6 is a block diagram of an embodiment of a portable computing device for incorporating the system of FIG. 1.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone”, “wireless communication device,” and “wireless handset” are used interchangeably. With the advent of third, fourth, and fifth generation (“3/4/5G”) wireless technology, greater bandwidth availability has enabled more portable computing devices with a greater variety of wireless capabilities. Therefore, a portable computing device may include a cellular telephone, a smartphone, a pager, a personal digital assistant (PDA), a navigation device, a wearable device (e.g., a smartwatch, fitness watch), any handheld computer with a wireless connection or link, Internet of Things (IoTs) devices, etc.

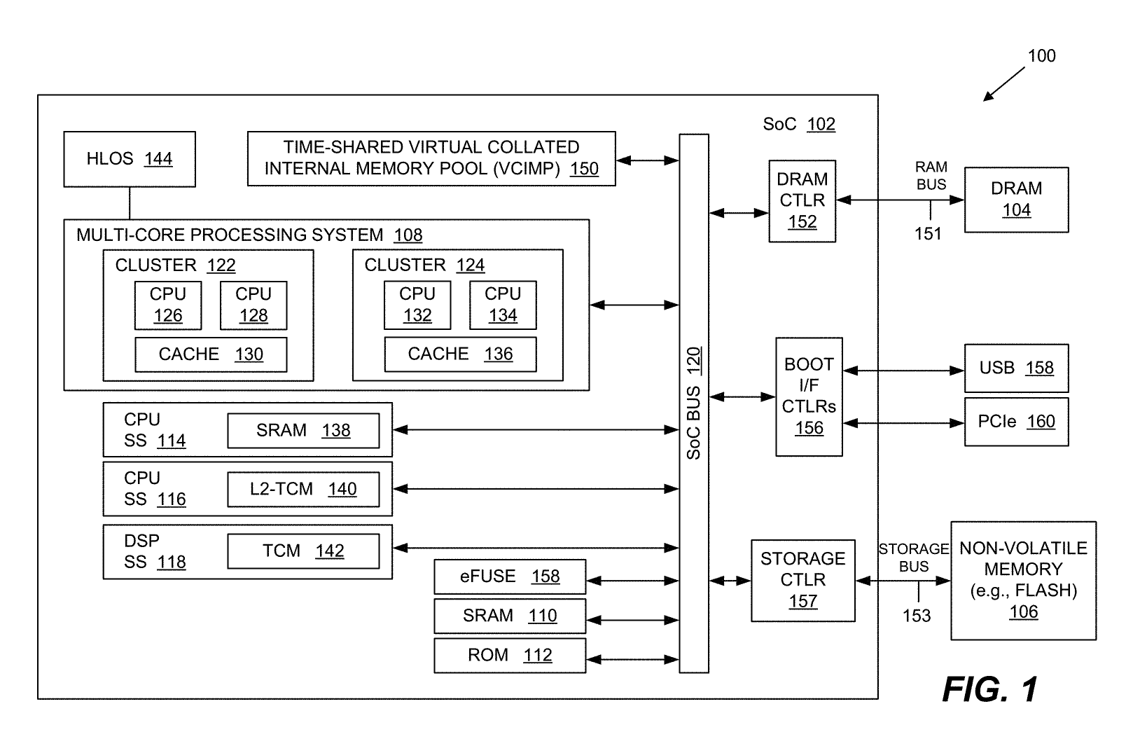

FIG. 1 illustrates an embodiment of a system 100 comprising an intelligent, flexible design for securely booting a system on chip (SoC) 102. The system 100 may be implemented in any computing device, including a personal computer, a workstation, a server, a portable computing device (PCD), such as a cellular telephone, a smartphone, a portable digital assistant (PDA), a portable game console, a navigation device, a tablet computer, a wearable device, such as a sports watch, a fitness tracking device, etc., or other battery-powered, web-enabled devices.

As described below in more detail, the system 100 collates various internal memories on dedicated components residing on the SoC 102 into a virtual collated internal memory map (VCIMP) 150. The VCIMP 150 may comprise a contiguous virtual memory map, which may be directly accessed (e.g., direct memory access (DMA), read/write, etc.) by a plurality of SoC masters. In this regard, it should be appreciated that the VCIMP 150 may support a hardware framework that provides connectivity to the plurality of SoC masters, an access protection unity capability, and system memory map allocation capability. In this regard, the VCIPM 150 appears as a single shared internal memory pool for time-shared, intelligent and secure use by the SoC masters during the boot-up of the SoC 102. The VCIMP 150 enables various methods for optimizing internal memory usage in the SoC 102. It should be further appreciated that the VCIMP 150 enables an intelligent temporal sharing framework in, for example, hardware that boot firmware may better use and, thereby, reduce SoC AuC, optimize off-the-shelf and improved processor designs supporting register transfer level (RTL) without adding complexities of custom wrappers, and enable integration of different chip CPU cores and derivative chip customization.

FIG. 1 illustrates an exemplary SoC 102 for implementing the timeshared VCIMP 150. The SoC 102 may be electrically coupled to volatile random access memory (VRAM) device(s) and non-volatile storage device(s). The VRAM may comprise a dynamic random access memory (DRAM) 104 electrically coupled to a DRAM controller 152 via a random access memory (RAM) bus 151. DRAM controller 152 manages the flow of data going to and from the DRAM 104 via RAM bus 151. DRAM controller 152 generally comprises the logic for reading and writing to DRAM 104. The non-volatile storage device may comprise a non-volatile block memory 106 comprising any type of high-performance non-volatile memory, including, for example, a flash memory, a phase-change memory, a ferroelectric memory, or a magnetoresistive memory. The non-volatile block memory 106 is electrically coupled to a storage controller 157 via a storage bus 153. The SoC 102 may support additional data interfaces to external components (e.g., Universal Serial Bus (USB) 158, Peripheral Component Interconnect Express (PCIe) 160, etc.) via boot interface controller(s) 156.

The SoC 102 comprises various on-chip components. In the embodiment of FIG. 1, the SoC 102 comprises the following components electrically coupled via an SoC bus 120: a multi-core processing system 108; one or more processing subsystems; the DRAM controller 152; the storage controller 157; the boot interface controller(s) 156; a static random access memory (SRAM) 110; and a read only memory (ROM) 112.

The multi-core processing system 108 may support a heterogeneous processor cluster architecture comprising a plurality of processor clusters coupled to a cache controller. As known in the art, each processor cluster may comprise one or more processors or processor cores (e.g., central processing unit (CPU), graphics processing unit (GPU), digital signal processor (DSP), etc.) with a corresponding shared cache.

In the embodiment of FIG. 1, the processor clusters 122 and 124 may comprise a “big.LITTLE” heterogeneous architecture in which the processor cluster 122 comprises a Little cluster and the processor cluster 124 comprises a Big cluster. The Little processor cluster comprises a plurality of central processing unit (CPU) cores 126 and 128, which are relatively slower and consume less power than the CPU cores 132 and 134 in the Big processor cluster 124. It should be appreciated that the Big cluster CPU cores 132 and 134 may be distinguished from the Little cluster CPU cores 126 and 128 by, for example, a relatively higher instructions per cycle (IPC), higher operating frequency, and/or having a micro-architectural feature that enables relatively more performance but at the cost of additional power.

Processor clusters 122 and 124 may have independent shared cache memory used by the corresponding processors in the cluster to reduce the average time to access data from a main memory. In an embodiment, the shared cache memory and the main memory may be organized as a hierarchy of cache levels (e.g., level one (L1), level two (L2), level three (L3). In the embodiment illustrated in FIG. 1, processor cluster 122 comprises a shared cache 130 dedicated to CPUs 126 and 128, and processor cluster 124 comprises a shared cache 136 dedicated to CPUs 132 and 134. It should be appreciated that the shared cache may be implemented with or without a hierarchy of cache levels.

The multi-core processing system 108 may execute a high-level operating system (HLOS) 144 configured to generate and/or access the time-shared VCIMP 150. As described below in more detail, the VCIMP 150 may be hardcoded in a designated register transfer layer (RTL) or configured by the HLOS 144.

As further illustrated in the embodiment of FIG. 1, the additional SoC processor subsystems may comprise, for example, a CPU subsystem 114 having an internal memory (SRAM 138), a digital signal processor (DSP) subsystem having an internal memory (tightly coupled memory (TCM) 142, and a CPU subsystem 116 having an internal memory (L2-TCM) 140. In this regard, the system 100 may collate the dedicated internal memories comprising the cache 130, the cache 136, SRAM 138, L2-TCM 140, and TCM 142 into VCIMP 150.

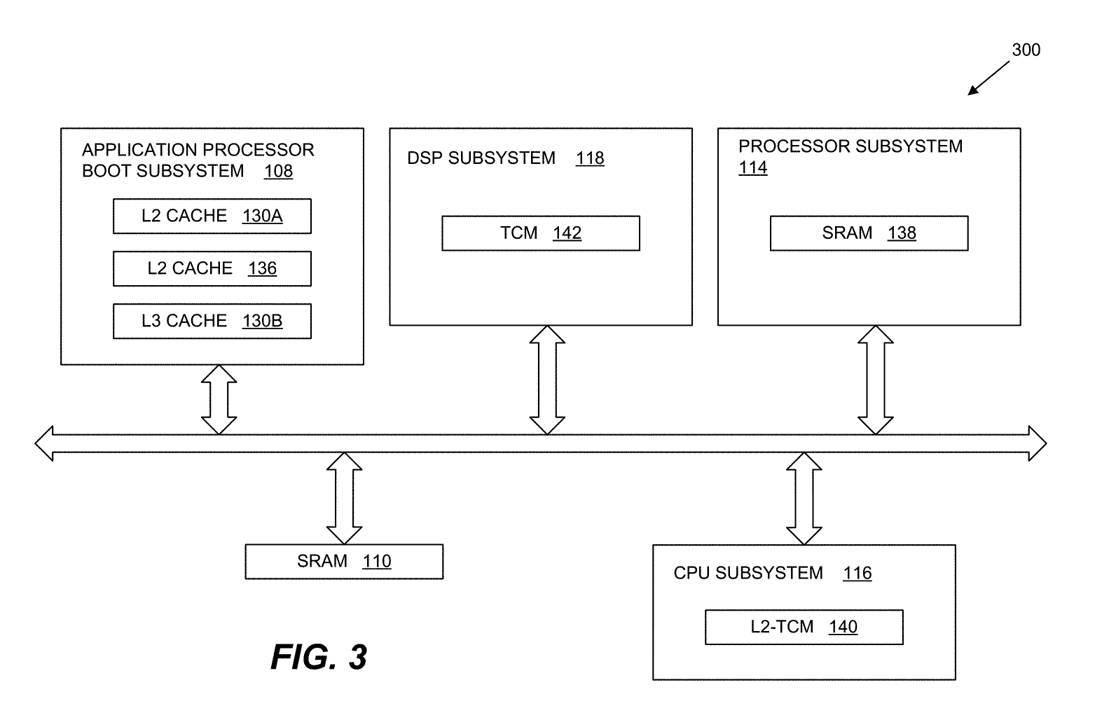

It should be appreciated that system 100 may support flexible memory map layouts for the temporal sharing. The flexible memory map layouts enable software to dynamically infer and enable intelligent decision-making through late-in-product-cycle and SKU/derivative chip options. FIG. 3 illustrates an exemplary embodiment of a plurality of dedicated chip memories on the SoC 102 used to generate a time-shared VCIMP 150. The multi-core processing system 108 may support an application processor boot subsystem having three separate internal memories. A first internal memory comprises L2 cache 130A from shared cache 130 in processor cluster 122. A second internal memory comprises L3 cache 130B from shared cache 130 in processor cluster 122. A third internal memory comprises L2 cache 136 from shared cache 136 in processor cluster 124. A fourth internal memory comprises tightly coupled memory (TCM) 142 residing on DSP subsystem 118. A fifth internal memory comprises SRAM 138 residing on CPU subsystem 114. A sixth internal memory comprises L2-TCM 140 residing on CPU subsystem 116. A seventh chip memory used to generate the VCIMP 150 may comprise standalone SRAM 110.

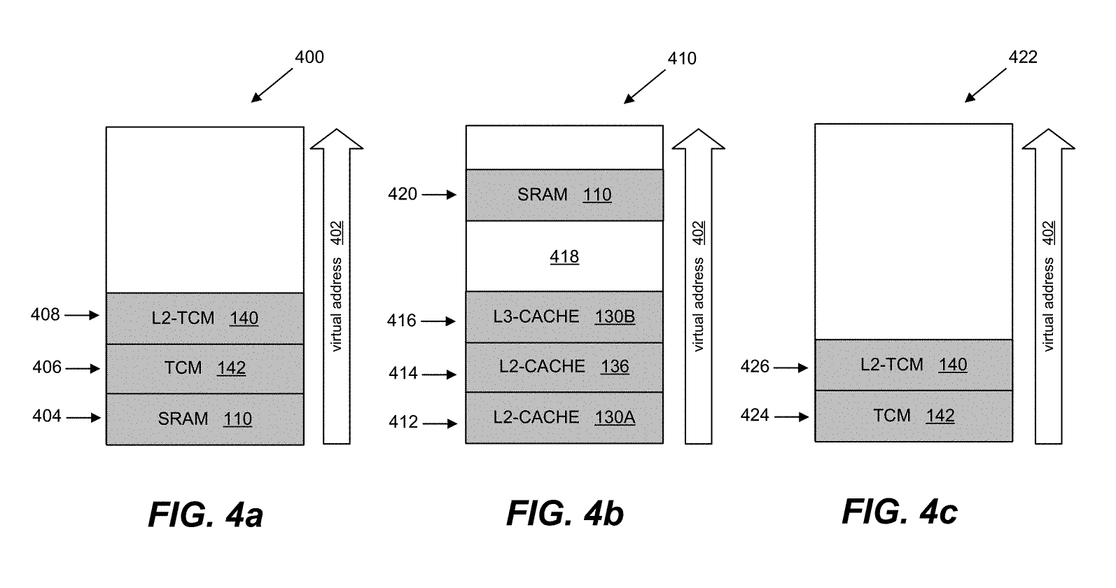

The SoC 102 may collate one or more of the dedicated memories illustrated in FIG. 3 into the time-shared VCIMP 150. FIG. 4a illustrates one embodiment of a VCIMP memory map 400. The memory map 400 comprises a contiguous mapping of virtual addresses 402. A first portion 404 of the virtual addresses 402 are mapped to the physical addresses associated with SRAM 110. A second portion 406 of the virtual addresses 402 are mapped to the physical addresses associated with SRAM TCM 142. A third portion 408 of the virtual addresses 402 are mapped to the physical addresses associated with L2-TCM 140.

FIG. 4b illustrates another embodiment of a VCIMP memory map 410. The VCIMP memory map 410 comprises two separate contiguous virtual address ranges separated by an unused range 418 of virtual addresses. A first contiguous portion of virtual addresses 402 comprises address ranges 412, 414, and 416. Address range 412 is mapped to the physical addresses associated with L2-cache 130A. Address range 414 is mapped to the physical addresses associated with L2-cache 136. Address range 416 is mapped to the physical addresses associated with L3-cache 130B. A second contiguous portion of virtual addresses comprises address range 420, which is mapped to the physical addresses associated with SRAM 110.

FIG. 4c illustrates a further embodiment of a VCIMP memory map 422. The memory map 420 comprises a contiguous mapping of virtual addresses 402. A first portion 424 of the virtual addresses 402 are mapped to the physical addresses associated with TCM 142. A second portion 426 of the virtual addresses 402 are mapped to the physical addresses associated with L2-TCM 140.

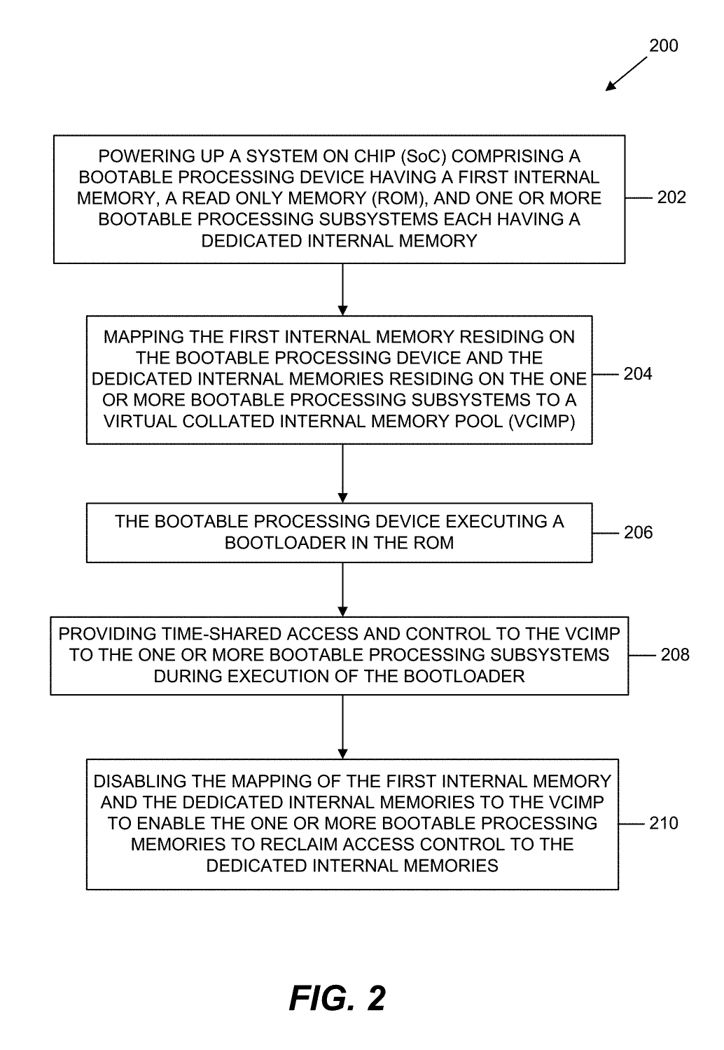

FIG. 2 illustrates an embodiment of a method 200 for securely booting the SoC 102 via the time-shared VCIMP 150. At block 202, the method 200 powers up the SoC 102. The SoC 102 comprises a bootable processing device having a first internal memory, a read only memory (ROM), and one or more bootable processing subsystems each having a dedicated internal memory. The bootable processing device may comprise one or more of the CPUs 126, 128, 132, and 134 in the multi-core processing system 108. Accordingly, the first internal memory may comprise the cache 130, the cache 136, or a portion thereof. The one or more bootable processing systems (and corresponding dedicated internal memories) may comprise CPU subsystem 114, CPU subsystem 116, and DSP subsystem 118.

At block 204, the method 200 maps the first internal memory residing on the bootable processing device and the dedicated internal memories residing on the corresponding one or more bootable processing subsystems to a virtual collated internal memory pool (VCIMP) 150. At block 206, the bootable processing device executes a bootloader in ROM 112. At block 208, the method 200 provides time-shared or temporal access to the VCIMP 150 to the one or more bootable processing subsystems during execution of the bootloader. In an embodiment, the time-shared access to the first internal memory and the dedicated internal memories may be performed until the bootable processing subsystems are brought out of a reset state. The time-shared access may be performed during a plurality of stages of the boot procedure, and may terminate upon entry into HLOS 144. At block 210, the method 200 may disable the mapping of the first internal memory and the dedicated internal memories to the VCIMP 150 to enable the one or more bootable processing subsystems to reclaim access control of their dedicated internal memories.

In this manner, the time-shared memory region provided via the VCIMP 160 may be made available to any SoC component/master, as needed, during an initial boot sequence of the SoC 102. The time-shared access during the boot process may be managed as a time-shared resource among clients or it can be managed as a group of memory segments, one for each client. Regardless the implementation, the respective clients use the VCIMP 150 to locally access the collated internal memories. The time-shared memory may no longer be accessible as VCIMP 150 by the clients after boot is completed. It should be appreciated that the time-shared access may refer to the usage of the VCIMP 150 during boot by, for example, one client for a period of time and then another client for another period of time, and so one. In other embodiments, the virtual memory space may be partitioned such that each client gets a portion of it during boot.

The VCIMP 150 may support a hardware framework that provides connectivity from different SoC masters, access protection unit capability, and system memory map allocation capability to collate the multiple scattered internal memories in the SoC 102 and make them appear as a single shared internal memory pool for temporal use intelligently and securely. It should be appreciated that post-boot usage of the VCIMP 150 may include further logic to relinquish, under secure control, the VCIMP 150 to their respective processor and functional subsystems. In one embodiment, the details of the different memories mapped to the VCIMP 150 may be implemented in hardware RTL through registers or software-maintained tables with information on ranges and attributes or parameters (such as whether the memory is cacheable or not, the type of SoC master accessibility (e.g., UFS, PCIe, USB, DMA, etc.)) which software may infer and intelligently allocated. It should be further appreciated that this hardware framework may enables the SoC leverage across chips in the same family/architecture and derivative chips/SKUs that may fuse out certain CPUs or subsystems (e.g., via eFuse 158). One exemplary implementation strategy may be to enable an application processor's instruction cache and/or data cache while executing or accessing the time-shared VCIMP 150 during boot for boot-time KPI competitiveness.

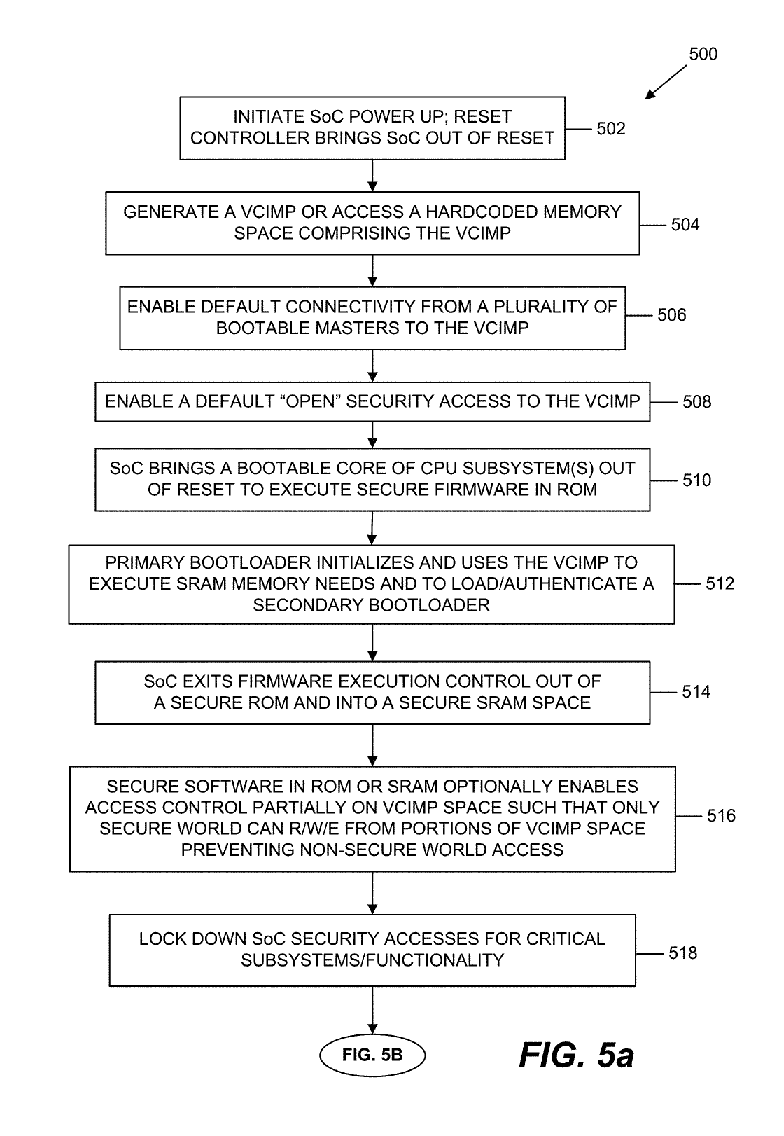

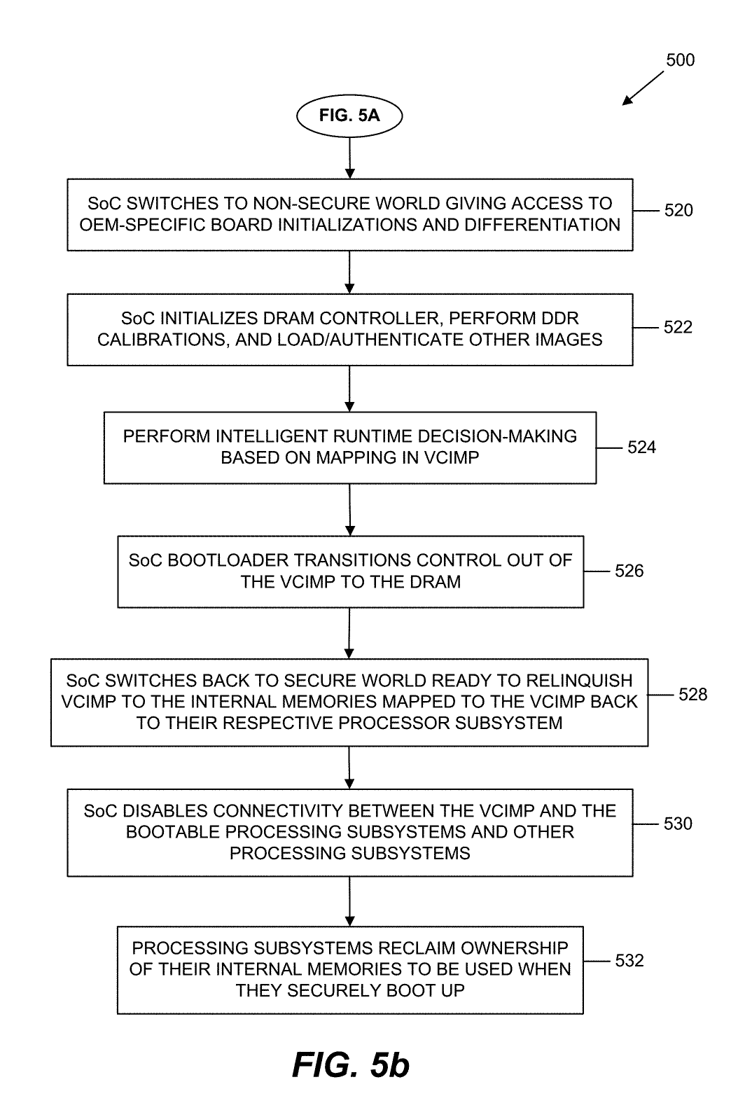

FIG. 5 illustrates another embodiment of a method 500 for securely booting the SoC 102 via a time-shared virtual collated internal memory pool 150. At block 502, the SoC 102 may be powered up by, for example, a reset controller (not shown) that brings the SoC 102 out of a reset state. In response to the SoC 102 being powered up, at block 504, the SoC 102 may generate the VCIMP 150 or access a hardcoded memory space comprising the VCIMP 150. For example, the SoC 102 may map the VCIMP 150 in hardware, and ROM firmware 112 may access the hardcoded memory space comprising the VCIMP 150. In another embodiment, SoC hardware may collate a designated register transfer level (RTL) set of internal memory physical addresses across a plurality of bootable processing subsystems in the system 100. The collated physical addresses are mapped to a VCIMP 150 for temporary use by a bootable processing subsystem (e.g., a CPU residing in the multi-core processing system 108). In another embodiment, the SoC 102 may configure the internal memories (portions thereof) and the corresponding physical addresses to be mapped to the VCIPM 150.

At block 506, the SoC 102 may enable a default connectivity state from a plurality of bootable masters (e.g., flash controller 157, boot interface controllers 156 to USB 158 and/or PCIe 160, etc.) to the VCIMP 150. In this regard, the default connectivity state enables the various SoC masters to directly access (e.g., direct memory access (DMA), read/write access) the coalesced memories in the VCIMP 150. At block 508, the SoC 102 may enable a default “open” security access state to the VCIPM 150. The SoC 102 may bring a bootable core of CPU subsystem(s) out of reset to execute secure firmware in ROM 112 (block 510). The bootable core of CPU subsystem(s) may comprise, for example, one of the CPUs residing in the process cluster 122 or the process cluster 124.

It should be appreciated that the VCIMP 150 enables a boot process that separately provides secure and non-secure access control. A secure world or mode of operation is illustrated in blocks 512, 514, 516, 518, and 520. A non-secure world or mode of operation is illustrated in blocks 522, 524, and 526. In this manner, low-level access control may be configured for both the secure and non-secure world ranges in the same coalesced memory range provided by VCIMP 150.

At block 512, a primary bootloader (e.g., BootROM) may initialize and use the VCIMP 150 to execute SRAM 110 memory needs and to load/authenticate a secondary bootloader. In an embodiment, SRAM memory needs may include executable-software RAM needs, such as, for example, stack, heap, scratch memory, etc. It should be appreciated that the terms primary bootloader and secondary bootloader generally refer to different stages of boot firmware (e.g., boot firmware in ROM versus RAM). A primary boot stage may be executed from ROM 112. A secondary boot stage may be executed pre-DDR from internal SRAM 110. A tertiary boot stage may be executed from DRAM 104.

At block 514, the SoC 102 may exit firmware execution control out of a secure ROM (e.g., ROM 112) and into a secure SRAM space (e.g., SRAM 110). Secure software in ROM 112 or SRAM 110 may optionally enable access control partially on VCIMP 150 space (block 516), such that only secure logic can read and/write from portions of VCIMP 150, thereby preventing non-secure access. At block 518, the method 500 may lock down security accesses for critical processor subsystems and/or functionality. In an ARM-based embodiment, Trustzone-based differentiation may be used to differentiate a secure world versus a non-secure world, which the SoC 102 may use to lock down certain resources, hardware, functionality, features, etc. that may be enabled/disabled in secure world firmware but not in non-secure world firmware. In other embodiments, the SoC 102 may choose to implement similar separation of secure versus non-secure worlds using local security protection units in hardware with their own signaling of secure versus non-secure state of execution.

At block 520, the SoC 102 may switch to a non-secure mode of operation in which access may be given to, for example, OEM-specific board initializations and differentiation. At block 522, the SoC 102 may initialize the DRAM controller 152 and perform operations, such as, DDR calibrations, etc. and load and/or authenticate other images in the SoC 102. For example, the SoC 102 may handle various non-secure early boot initializations. In this regard, the SoC 102 may be configured to make various intelligent decisions (block 524) depending on the mapping in VCIMP 150 to, for example, tackle destination address of executables and data segments. For example, intelligent runtime decision-making may be based on memory checks in the coalesced memory range of the VCIMP 150 to accommodate different types of processor subsystems with variable internal memory sizes, as well as, improved binning and process node yield improvement options. At block 526, the SoC bootloader may transition control out of the VCIMP 150 to the DRAM 104. In one embodiment, post-ROM bootloader firmware may transition control, although any ROM-based bootloader (primary) or post-ROM-based bootloader firmware (secondary, tertiary, etc.) may be implemented. At block 528, the SoC 102 may switch back to a secure mode of operation to relinquish the internal memories mapped to the VCIMP 150 back to their respective processor subsystems. At block 530, the SoC 102 may disable connectivity between the VCIMP 150 and the bootable processing subsystems and other processing subsystems on the SoC 102. At block 532, the processing subsystems may reclaim ownership of their internal memories to be used when the securely boot up.

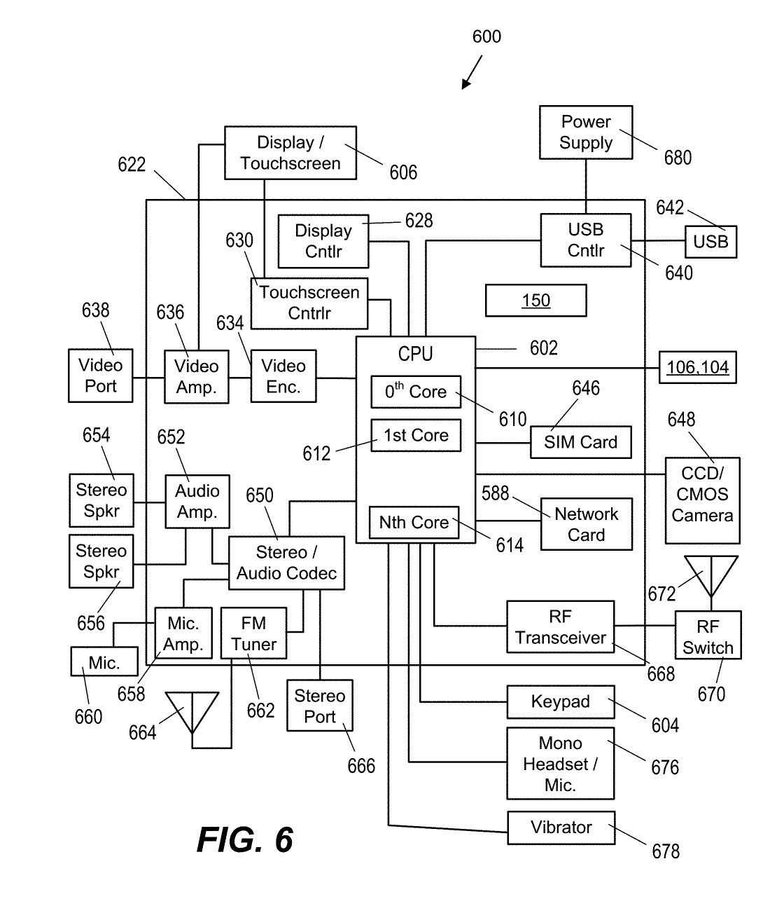

As mentioned above, the system 100 may be incorporated into any desirable computing system. FIG. 6 illustrates the system 100 incorporated in an exemplary portable computing device (PCD) 600. It will be readily appreciated that certain components of the system 100 are included on the SoC 622 (FIG. 6) while other components (e.g., the DRAM 104 and the non-volatile block memory 106) are external components coupled to the SoC 622. The SoC 622 may include a multicore CPU 602. The multicore CPU 602 may include a zeroth core 610, a first core 612, and an Nth core 614. One of the cores may comprise, for example, a graphics processing unit (GPU) with one or more of the others comprising the CPU. Furthermore, as mentioned above, the VCIMP 150 may be embodied in SoC hardware.

A display controller 628 and a touch screen controller 630 may be coupled to the CPU 602. In turn, the touch screen display 606 external to the on-chip system 622 may be coupled to the display controller 628 and the touch screen controller 630.

FIG. 6 further shows that a video encoder 634, e.g., a phase alternating line (PAL) encoder, a sequential color a memoire (SECAM) encoder, or a national television system(s) committee (NTSC) encoder, is coupled to the multicore CPU 602. Further, a video amplifier 636 is coupled to the video encoder 634 and the touch screen display 606. Also, a video port 638 is coupled to the video amplifier 636. As shown in FIG. 6, a universal serial bus (USB) controller 640 is coupled to the multicore CPU 602. Also, a USB port 642 is coupled to the USB controller 640.

Further, as shown in FIG. 6, a digital camera 648 may be coupled to the multicore CPU 602. In an exemplary aspect, the digital camera 648 is a charge-coupled device (CCD) camera or a complementary metal-oxide semiconductor (CMOS) camera.

As further illustrated in FIG. 6, a stereo audio coder-decoder (CODEC) 650 may be coupled to the multicore CPU 602. Moreover, an audio amplifier 652 may coupled to the stereo audio CODEC 650. In an exemplary aspect, a first stereo speaker 654 and a second stereo speaker 656 are coupled to the audio amplifier 652. FIG. 6 shows that a microphone amplifier 658 may be also coupled to the stereo audio CODEC 650. Additionally, a microphone 660 may be coupled to the microphone amplifier 658. In a particular aspect, a frequency modulation (FM) radio tuner 662 may be coupled to the stereo audio CODEC 650. Also, an FM antenna 664 is coupled to the FM radio tuner 662. Further, stereo headphones 666 may be coupled to the stereo audio CODEC 650.

FIG. 6 further illustrates that a radio frequency (RF) transceiver 668 may be coupled to the multicore CPU 602. An RF switch 670 may be coupled to the RF transceiver 668 and an RF antenna 672. A keypad 604 may be coupled to the multicore CPU 602. Also, a mono headset with a microphone 676 may be coupled to the multicore CPU 602. Further, a vibrator device 678 may be coupled to the multicore CPU 602.

FIG. 6 also shows that a power supply 680 may be coupled to the on-chip system 622. In a particular aspect, the power supply 680 is a direct current (DC) power supply that provides power to the various components of the PCD 600 that require power. Further, in a particular aspect, the power supply is a rechargeable DC battery or a DC power supply that is derived from an alternating current (AC) to DC transformer that is connected to an AC power source.

FIG. 6 further indicates that the PCD 600 may also include a network card 688 that may be used to access a data network, e.g., a local area network, a personal area network, or any other network. The network card 688 may be a Bluetooth network card, a WiFi network card, a personal area network (PAN) card, a personal area network ultra-low-power technology (PeANUT) network card, a television/cable/satellite tuner, or any other network card well known in the art. Further, the network card 688 may be incorporated into a chip, i.e., the network card 688 may be a full solution in a chip, and may not be a separate network card 688.

As depicted in FIG. 6, the touch screen display 606, the video port 638, the USB port 642, the camera 648, the first stereo speaker 654, the second stereo speaker 656, the microphone 660, the FM antenna 664, the stereo headphones 666, the RF switch 670, the RF antenna 672, the keypad 674, the mono headset 676, the vibrator 678, and the power supply 680 may be external to the on-chip system 622.

It should be appreciated that one or more of the method steps described herein may be stored in the memory as computer program instructions, such as the modules described above. These instructions may be executed by any suitable processor in combination or in concert with the corresponding module to perform the methods described herein.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, NAND flash, NOR flash, M-RAM, P-RAM, R-RAM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A method for securely booting a system on chip (SoC), the method comprising:
powering up a system on chip (SoC) comprising a bootable processing device having a first internal memory, a read only memory (ROM), and one or more bootable processing subsystems each having a dedicated internal memory;
mapping the first internal memory residing on the bootable processing device and the dedicated internal memories residing on the corresponding one or more bootable processing subsystems to a virtual collated internal memory pool (VCIMP);
the bootable processing device executing a bootloader in the ROM; and
providing time-shared access to the VCIMP to the one or more bootable processing subsystems during execution of the bootloader.

2. The method of claim 1, wherein the bootable processing device comprises a central processing unit (CPU) core, and the one or more bootable processing subsystems comprise one or more of a digital signal processor (DSP) subsystem and a CPU subsystem.

3. The method of claim 1, wherein the first internal memory residing on the bootable processing device comprises a cache.

4. The method of claim 1, wherein the dedicated internal memory residing on the one or more bootable processing subsystems comprises one or more of a cache, a static random access memory (SRAM), and a tightly coupled memory (TCM).

5. The method of claim 1, further comprising:
disabling the mapping of the first internal memory and the dedicated internal memories to the virtual collated internal memory pool (VCIMP);
the one or more bootable processing subsystems reclaiming access control of the dedicated internal memories.

6. The method of claim 5, further comprising:
securely booting up the one or more bootable processing subsystems.

7. The method of claim 1, wherein the providing time-shared access to the VCIMP to the one or more bootable processing subsystems during execution of the bootloader comprises:
a first bootable processing subsystem accessing the VCIMP for a first period of time during execution of the bootloader; and
a second bootable processing subsystem accessing the VCIMP for a second period of time during execution of the bootloader.

8. A system for securely booting a system on chip (SoC), the method comprising:
means for powering up a system on chip (SoC) comprising a bootable processing device having a first internal memory, a read only memory (ROM), and one or more bootable processing subsystems each having a dedicated internal memory;
means for mapping the first internal memory residing on the bootable processing device and the dedicated internal memories residing on the corresponding one or more bootable processing subsystems to a virtual collated internal memory pool (VCIMP);
means for executing a bootloader in the ROM; and
means for providing time-shared access to the VCIMP to the one or more bootable processing subsystems during execution of the bootloader.

9. The system of claim 8, wherein the bootable processing device comprises a central processing unit (CPU) core, and the one or more bootable processing subsystems comprise one or more of a digital signal processor (DSP) subsystem and a CPU subsystem.

10. The system of claim 8, wherein the first internal memory residing on the bootable processing device comprises a cache.

11. The system of claim 8, wherein the dedicated internal memory residing on the one or more bootable processing subsystems comprises one or more of a cache, a static random access memory (SRAM), and a tightly coupled memory (TCM).

12. The system of claim 8, further comprising:
means for disabling the mapping of the first internal memory and the dedicated internal memories to the virtual collated internal memory pool (VCIMP);
means for enabling the one or more bootable processing subsystems reclaiming access control of the dedicated internal memories.

13. The system of claim 12, further comprising:
means for securely booting up the one or more bootable processing subsystems.

14. The system of claim 8, wherein the means for providing time-shared access to the VCIMP during execution of the bootloader comprises:
a first bootable processing subsystem accessing the VCIMP for a first period of time during execution of the bootloader; and
a second bootable processing subsystem accessing the VCIMP for a second period of time during execution of the bootloader.

15. A computer program embodied in a non-transitory computer readable medium and executable by a processor for securely booting a system on chip (SoC), the computer program comprising logic configured to:
power up a system on chip (SoC) comprising a bootable processing device having a first internal memory, a read only memory (ROM), and one or more bootable processing subsystems each having a dedicated internal memory;
map the first internal memory residing on the bootable processing device and the dedicated internal memories residing on the corresponding one or more bootable processing subsystems to a virtual collated internal memory pool (VCIMP);
execute a bootloader in the ROM; and
provide time-shared access to the VCIMP to the one or more bootable processing subsystems during execution of a secondary bootloader.

16. The computer program of claim 15, wherein the bootable processing device comprises a central processing unit (CPU) core, and the one or more bootable processing subsystems comprise one or more of a digital signal processor (DSP) subsystem and a CPU subsystem.

17. The computer program of claim 15, wherein the first internal memory residing on the bootable processing device comprises a cache.

18. The computer program of claim 15, wherein the dedicated internal memory residing on the one or more bootable processing subsystems comprises one or more of a cache, a static random access memory (SRAM), and a tightly coupled memory (TCM).

19. The computer program of claim 15, further comprising logic configured to:
disable the mapping of the first internal memory and the dedicated internal memories to the virtual collated internal memory pool (VCIMP);
enable the one or more bootable processing subsystems to reclaim access control of the dedicated internal memories.

20. The computer program of claim 19, further comprising logic configured to:
securely boot up the one or more bootable processing subsystems.

21. The computer program of claim 19, wherein the logic configured to provide time-shared access to the VCIMP involves:
a first bootable processing subsystem accessing the VCIMP for a first period of time during execution of the bootloader; and
a second bootable processing subsystem accessing the VCIMP for a second period of time during execution of the bootloader.

22. A system for securely booting a system on chip, the system comprising:
a system on chip comprising a bootable processing device having a first internal memory, a read only memory (ROM), and one or more bootable processing subsystems each having a dedicated internal memory, the bootable processing device configured to execute a bootloader in the ROM; and
a virtual collated internal memory pool (VCIMP) for providing time-shared control and access to the one or more bootable processing subsystems during execution of a boot sequence, the VCIMP comprising a contiguous logical-to-physical address mapping of the first internal memory residing on the bootable processing device and the dedicated internal memories residing on the corresponding one or more bootable processing subsystems.

23. The system of claim 22, wherein the bootable processing device executes a primary bootloader in the ROM.

24. The system of claim 22, wherein the time-shared control and access via the VCIMP occurs during execution of a secondary bootloader.

25. The system of claim 22, wherein the bootable processing device comprises a central processing unit (CPU) core, and the one or more bootable processing subsystems comprise one or more of a digital signal processor (DSP) subsystem and a CPU subsystem.

26. The system of claim 22, wherein the first internal memory residing on the bootable processing device comprises a cache.

27. The system of claim 22, wherein the dedicated internal memory residing on the one or more bootable processing subsystems comprises one or more of a cache, a static random access memory (SRAM), and a tightly coupled memory (TCM).

28. The system of claim 22, wherein the VCIMP is disabled to enable the one or more bootable processing subsystems to reclaim access control of the dedicated internal memories.

29. The system of claim 28, further comprising:
the one or more bootable processing subsystems securely booting up while the VCIMP is disabled.

30. The system of claim 22, wherein the SoC is incorporated in a portable computing device comprising one of a smartphone, a tablet computer, a wearable computing device, and a portable gaming device.
